(19) United States
(12) Patent Application Publication
(10) Pub. No.: US 2026/0201211 A1
(43) Pub. Date: Jul. 16, 2026

(54) AN EMULSIFIER COMPOSITION FOR A WATERBORNE ALKYD COMPOSITION

(71) Applicant: PERSTORP AB, Perstorp (SE)

(72) Inventors: Magnus KOKKO, Perstorp (SE); Håkan BJÖRNBERG, Malmö (SE); David LÖF, Vellinge (SE); Marie WESTERBLAD, Hässleholm (SE); Süleyman KUDRET, Perstorp (SE)

(73) Assignee: PERSTORP AB, Perstorp (SE)

(21) Appl. No.: 19/138,354

(22) PCT Filed: Dec. 14, 2023
(86) PCT No.: PCT/SE2023/051255

§ 371 Date: Jun. 12, 2025

(30) Foreign Application Priority Data
Dec. 14, 2022 (SE) 2230414-1

(51) Int. Cl. C09D 191/00; C08G 63/48; C09D 5/02

(52) U.S. Cl. CPC C09D 191/005; C08G 63/48; C09D 5/027

(57) ABSTRACT

The present invention relates to an emulsifier composition comprising at least one anionic emulsifier and at least one non-ionic emulsifier. The invention further relates to the use of said emulsifier composition for producing a waterborne alkyd composition, to a waterborne alkyd composition comprising the emulsifier composition of the invention, and to a method for producing said waterborne alkyd composition.

### FIELD OF THE INVENTION

The present invention relates to an emulsifier composition comprising at least one anionic emulsifier and at least one non-ionic emulsifier. The invention further relates to the use of said emulsifier composition for producing a waterborne alkyd composition, to a waterborne alkyd composition comprising the emulsifier composition of the invention, and to a method for producing said waterborne alkyd composition.

### BACKGROUND OF THE INVENTION

Coating compositions, also known as paints, have gone through a radical change over the last couple of decades. In some parts of the world this change is still ongoing. The aim to reduce the amount of organic solvents used in coatings have led to radically increased use of waterborne coating compositions. Alkyd coating compositions are well-known in the coating industry for their many qualities, like their ability to provide hard, glossy and long-lasting finishes on various surfaces. Alkyd coatings are historically based on solvents and dry by solvent evaporation and cure by oxidation, resulting in a robust coating. There is however an ongoing switch from solventborne to waterborne also for alkyd coatings. Waterborne alkyd coatings combine the best of both worlds: the benefits of alkyd resins and the eco-friendliness of water-based systems.

Waterborne alkyd coatings do however face some challenges. For instance waterborne alkyd coatings take longer time to dry compared to solventborne coatings. The application outcome however is comparable in terms of flow, levelling, and gloss characteristics. Achieving a robust film formation with waterborne alkyds can be tricky. Proper formulation and curing conditions are crucial to ensure a good coating performance. Maintaining a stable viscosity during storage and application is essential and challenging. Finding an emulsifier that is able to procedure a suitable alkyd droplet size is difficult, but fundamental for the stability of waterborne alkyd emulsions. Waterborne alkyds often strike a balance between performance (such as hardness, gloss, and durability) and environmental considerations. Finding the right compromise can be challenging.

### SUMMARY OF THE INVENTION

The Applicant has observed that emulsifiers play a crucial role when converting alkyd resins into waterborne emulsions and the Applicant has surprisingly found a specific emulsifier composition that makes it possible to form a waterborne alkyd emulsion having an alkyd droplet size that reassures a long term stability. This finding enables formulators to make the transition from solventborne to waterborne alkyd emulsions and thereby contribute to more sustainable and environmental coatings.

The present invention therefore refers, in a first aspect, to an emulsifier composition for a waterborne alkyd composition, wherein said emulsifier composition comprises: at least one anionic emulsifier (i), being a fatty acid of 16 to 24 carbon atoms and having at least one unsaturation, and at least one non-ionic emulsifier (ii), having a HLB (Hydrophilic Lipophilic Balance) value in the range of 11-18.

Surprisingly, the Applicant has indeed found out that this emulsifier composition enables the formation of a waterborne alkyd emulsion with long term stability. There is a desire within the coating industry to produce coating compositions from bio-renewable sources. Many of the components in an alkyd are today possible to, partly or fully, source from bio-renewable material. As examples hereof can be mentioned Voxtar™, Evyron™ and Neeture™, tetra-alcohol, tri-alcohol and di-alcohol from Perstorp AB, but also short and long oils used to produce the polyol-esters of an alkyd. Emulsifiers constitute a considerable portion of a waterborne coating composition and there is accordingly a need to formulate also the emulsifiers from bio-renewable materials as much as possible. This need can be perfectly met by the emulsifier composition of the present invention, wherein said anionic emulsifier (i) preferably is fully bio-renewable, but also the non-ionic emulsifier (ii), advantageously is derived from a bio-renewable source.

The emulsifier composition of the invention can further preferably be formed without any amine terminated emulsifiers, which responds well with the desire in the coating industry to avoid the commonly used amine terminated emulsifiers since they are connected with environmental, health and visual property issues.

In a further aspect, the present invention refers also to the use the emulsifier composition according to the first aspect, for producing a waterborne alkyd composition. By using the emulsifier composition of the present invention it is possible to produce a stable waterborne alkyd composition.

In a still further aspect, the present invention therefore also relates to a waterborne alkyd composition, wherein said alkyd composition comprises: a) an alkyd resin having an acid number in the range of 2-20 mg KOH/g, b) an emulsifier composition according to the first aspect of the present invention, c) water, and d) a neutralizer.

In a yet further aspect, the present invention also relates to a method for producing the waterborne alkyd composition according to the present invention, comprising the steps of: (A) mixing the alkyd resin with the emulsifier composition, (B) adding the neutralizer under continuous stirring to the mixture resulting from step A) up to a pH in the range of 5-10, and thereafter (C) adding water under continuous stirring.

The emulsifier composition of the present invention facilitates the transition of alkyd resins into waterborne emulsions, making sustainable and long-term stable waterborne alkyd coatings possible.

The advantages of the these further aspects according to the present invention have been disclosed in relation to the emulsifier composition according to the first aspect of the present invention and are herewith not repeated.

### DETAILED DESCRIPTION OF THE INVENTION The present invention relates, in a first aspect, to an emulsifier composition for a waterborne alkyd composition, wherein said emulsifier composition comprises:

i. at least one anionic emulsifier, being a fatty acid of 16 to 24 carbon atoms and having at least one unsaturation, and
ii. at least one non-ionic emulsifier, having a HLB (Hydrophilic Lipophilic Balance) value in the range of 11-18.

Surprisingly, the Applicant has indeed found out that this emulsifier composition enables the formation of a waterborne alkyd emulsion with long term stability. Within the framework of the present description and in the subsequent claims, except where otherwise indicated, all the numerical entities expressing amounts, parameters, percentages, and so forth, are to be understood as being preceded in all instances by the term “about”. As used herein, the term “about” will be understood by persons of ordinary skill in the art and will vary to some extent on the context in which it is used. As used herein when referring to a measurable value such as an amount, a temporal duration, and the like, the term “about” is meant to encompass variations of ±20% or ±10%, including ±5%, ±1%, and ±0.1% from the specified value, as such variations are appropriate to perform the disclosed methods. Also, all ranges of numerical entities include all the possible combinations of the maximum and minimum values and include all the possible intermediate ranges, in addition to those specifically indicated herein below.

Unless defined otherwise, all technical and scientific terms used herein generally have the same meaning as commonly understood by one of ordinary skill in the art to which this invention belongs.

As used herein, the articles “a” and “an” refer to one or to more than one (i.e. to at least one) of the grammatical object of the article. By way of example, “a fatty acid” means one fatty acid or more than one fatty acid.

The present invention may present in one or more of the above aspects one or more of the characteristics disclosed hereinafter.

The emulsifier composition according to the present invention comprises at least one anionic emulsifier i), being a fatty acid of 16 to 24 carbon atoms and having at least one unsaturation, and at least one non-ionic emulsifier ii), having a HLB (Hydrophilic Lipophilic Balance) value in the range of 11-18. Preferably, said anionic emulsifier i), has at least one pendant hydroxyl group. In another preferred embodiment of the present invention, said anionic emulsifier i), has at least one branching.

Said anionic emulsifier i), is suitably a fatty acid selected from the group consisting of: palmitolinolenic acid, palmitidonic acid, palmitoleic acid, hydroxyhexadecanoic acid, margaric acid, heptadecenoic acid, hydroxyheptadecenoic acid, stearidonic acid, oleic acid, ricinoleic acid, isoricinoleic acid, ricinstearolic acid, linoleic acid, a-linolenic acid, linolelaidic acid, elaidic acid, agonandric acid, isanolic acid, coriolic acid, densipolic acid, nonadecenoic acid, paullinic acid, auricolic acid, gondoic acid, lesquerolic acid, heneicosenoic acid, erucic acid, cetoleic acid, eranthic acid, phellogenic acid, nebraskanic acid, wuhanic acid, and combinations thereof. More preferably, said anionic emulsifier i), is selected from the group consisting of: palmitoleic acid, oleic acid, ricinoleic acid, and linoleic acid.

In a further aspect, said anionic emulsifier i) could be a di-, tri- or oligomer of a fatty acid.

Preferably, said anionic emulsifier i), is derived from a bio-renewable source, like a vegetable oil. The fatty acid composition of a vegetable oil in general contains a mixture of monounsaturated, polyunsaturated and saturated fatty acids. Saturated fatty acids typically present in vegetable oils are for instance palmitic acid, stearic acid, nonadecylic acid, arachidic acid, heneicosylic acid, behenic acid, dihydroxybehenic acid, tricosylic acid, and lignoceric acid.

The anionic emulsifier i) in the emulsifier composition of the present invention is preferably present in an amount of 30-70% by weight, more preferably in an amount of 40-60% by weight, based on the emulsifier composition.

In a preferred embodiment of the present invention, said non-ionic emulsifier ii) is also derived from a bio-renewable source. For example the lipophilic part of said non-ionic emulsifier ii) is preferably selected from fatty acids having 14 to 20 carbon atoms that are readily available from a non-fossil source. The hydrophilic part of said non-ionic emulsifier ii) is suitably derived from alkoxylates such as poly-oxy-ethylene, oligomeric alkyl-ethene-oxides, alkyl-phenol-poly-ethylene or polysorbates. Preferably, said hydrophilic part comprises 5-40 ethylene oxide (EO) units. Ethylene oxide is readily available from bio-renewable sources and also other components of the hydrophilic part of said non-ionic emulsifier ii), like for instance glycol, alkyl phenol, and sorbitan, are available to a certain degree from bio-renewable sources.

In a further aspect, the present invention also relates to the use of an emulsifier composition as defined in the first aspect of the invention, for producing a waterborne alkyd composition.

In a still further aspect, the present invention also relates to a waterborne alkyd composition, wherein said alkyd composition comprises:
a) an alkyd resin having an acid number in the range of 2-20 mg KOH/g,
b) an emulsifier composition according to the first aspect of the invention,
c) water, and
d) a neutralizer.

Preferably, said alkyd resin a) has a droplet size in the range of 100 nm 350 nm.

Alkyd resin are polyesters that contain drying oils and are formed with three basic components: fatty acids, polyols, and dibasic acids. Triglycerides, i.e. oils consisting of 3 moles of monobasic fatty acid and 1 mole of glycerol, can replace the polyol and fatty acid. The choice of polyols affects the degree of branching in the alkyd resin. Suitable polyols for forming said alkyd resin a) in the waterborne alkyd composition of the present invention is selected from the group consisting of: glycerol, ethylene glycol, propylene glycol, pentaerythritol, dipentaerythritol, trimethylolpropane, and sorbitol.

The fatty acids or oils used to form the alkyd resin a) have a significant effect on the curing and physical properties of a final coating film. The more unsaturated the fatty acid, the shorter it takes for the coating to dry. Alkyds are classified according to the percentage of fatty acid in the resin. Short oil alkyds contain less than 40% fatty acids, medium oil alkyds between 40 and 60%, and long oil alkyds more than 60% fatty acids. The majority of the fatty acids comes from vegetable oils, of which soybean oil is the most utilized.

Dibasic acids used to prepare the alkyd are usually aromatic, like phthalic anhydride or isophthalic acid, but also aliphatic dicarboxylic acids, like succinic acid, adipic acid, azelaic acid, sebacic acid, and dimer fatty acids, may be used. The dibasic acids of said alkyd resin contributes with an increased elasticity of the coating film.

Preferably, said emulsifier composition b) is present in the range of 2-12% by weight based on said alkyd resin.

In a preferred embodiment of the present invention, said neutralizer d) is an alkali metal hydroxide, and/or ammonium hydroxide. Said alkali metal hydroxide is suitably selected from the group consisting of: lithium hydroxide, sodium hydroxide, potassium hydroxide, and combinations thereof. Market price of the specific alkali metal, but also the desired performance is a deciding factor when formulating the coating properties such as, but not limited to, film forming properties and gloss rate. A mixture between one or more alkali metal hydroxide and ammonia has in many cases shown to be a preferable solution. In a yet further aspect, the present invention also relates to a method for producing said waterborne alkyd composition according to the invention, comprising the steps of:
A. mixing the alkyd resin with the emulsifier composition,
B. adding the neutralizer under continuous stirring to the mixture resulting from step A) up to a pH in the range of 5-10, and thereafter
C. adding water under continuous stirring.

Preferably, the water in step C) is added dropwise.

Said method is preferably performed at an emulsifying temperature in the range of 50-90° C., more preferably 55-80° C.

The present invention is further explained with reference to enclosed embodiment Examples, which are to be construed as illustrative and not limiting in any way.

### EXAMPLES

### Embodiment Example 1

100 g of a TOFA (Tall Oil Fatty Acid) long oil alkyd with an acid number of 9.2 mg KOH/g and a hydroxyl number of 66.3 mg KOH/g was mixed with 8 grams of emulsifier composition in accordance with the invention where the anionic emulsifier was 4.8 g and the non-ionic emulsifier was 3.2 g. The alkyd emulsifier composition was then mixed for 15 minutes whereupon 2.38 g of KOH was added under continued mixing. 89.62 g of distilled water was then added at a rate of 1.2 g/minute under continued mixing. The emulsifying temperature was 55° C.

The alkyd droplets size was found to be uniform with a size in the range 175-225 nm. The long term stability was then analyzed by storing a sample at 50° C. for 30 days. No separation of the alkyd emulsion was detected.

### Embodiment Example 2

100 g of a Sunflower fatty acid long oil alkyd with an acid number of 2.8 mg KOH/g and a hydroxyl number of 54 mg KOH/g was mixed with 8 grams of emulsifier composition in accordance with the invention where the anionic emulsifier was 4 g and the non-ionic emulsifier was 4 g. The alkyd emulsifier composition was then mixed for 15 minutes whereupon 2.38 g of KOH was added under continued mixing. 90 g of distilled water was then added at a rate of 1.2 g/minute under continued mixing. The emulsifying temperature was 80° C.

The alkyd droplets size was found to be uniform with an average size 140 nm. The long term stability was then analyzed by storing a sample at 50° C. for 30 days. No separation of the alkyd emulsion was detected.

### Embodiment Example 3

100 g of a Soybean fatty acid long oil alkyd with an acid number of 16.8 mg KOH/g and a hydroxyl number of 74 mg KOH/g was mixed with 8 grams of emulsifier composition in accordance with the invention where the anionic emulsifier was 4 g and the non-ionic emulsifier was 4 g. The alkyd emulsifier composition was then mixed for 15 minutes whereupon 2.38 g of KOH was added under continued mixing. 91 g of distilled water was then added at a rate of 1.2 g/minute under continued mixing. The emulsifying temperature was 80° C.

The alkyd droplets size was found to be uniform with an average size 220 nm. The long term stability was then analyzed by storing a sample at 50° C. for 30 days. No separation of the alkyd emulsion was detected.

### Embodiment Example 4

100 g of a Soybean fatty acid short oil alkyd with an acid number of 9.3 mg KOH/g and a hydroxyl number of 57.4 mg KOH/g was mixed with 8 grams of emulsifier composition in accordance with the invention where the anionic emulsifier was 4 g and the non-ionic emulsifier was 4 g. The alkyd emulsifier composition was then mixed for 15 minutes whereupon 2.38 g of KOH was added under continued mixing.

88 g of distilled water was then added at a rate of 0.9 g/minute under continued mixing. The emulsifying temperature was 65° C.

The alkyd droplets size was found to be uniform with an average size 300 nm. The long term stability was then analyzed by storing a sample at 50° C. for 30 days. No separation of the alkyd emulsion was detected.

1-15. (canceled)

16. An emulsifier composition for a waterborne alkyd composition comprising:
(i) at least one anionic emulsifier, wherein the anionic emulsifier is a fatty acid having 16 to 24 carbon atoms and at least one site of unsaturation, and
(ii) at least one nonionic emulsifier having a Hydrophilic Lipophilic Balance (HLB) value in the range of 11 to 18.

17. The emulsifier composition of claim 16, wherein the anionic emulsifier (i) comprises at least one pendant hydroxyl group.

18. The emulsifier composition of claim 16, wherein the anionic emulsifier (i) comprises at least one branched alkyl or branched alkenyl group.

19. The emulsifier composition of claim 17, wherein the anionic emulsifier (i) comprises at least one branched alkyl or branched alkenyl group.

20. The emulsifier composition of 16, wherein the anionic emulsifier (i) is present in an amount of 30 to 70% by weight, based on a total weight of the emulsifier composition.

21. The emulsifier composition of 17, wherein the anionic emulsifier (i) is present in an amount of 30 to 70% by weight, based on a total weight of the emulsifier composition.

22. The emulsifier composition of 18, wherein the anionic emulsifier (i) is present in an amount of 30 to 70% by weight, based on a total weight of the emulsifier composition.

23. The emulsifier composition of claim 16, wherein the anionic emulsifier (i) is present in an amount of 40 to 60% by weight, based on the total weight of the emulsifier composition.

24. A method for producing a waterborne alkyd composition comprising combining the emulsifier composition of claim 16 with an alkyld resin and water.

25. A waterborne alkyd composition comprising:
(a) an alkyd resin having an acid number in the range of 2 to 20 mg KOH/g;
(b) the emulsifier composition of claim 16;
(c) water; and
(d) a neutralizer.

26. The waterborne alkyd composition of claim 25, wherein the alkyd resin (a) is present in the form of dispersed droplets having an average droplet size in the range of 100 nm to 350 nm.

27. The waterborne alkyd composition of claim 25, wherein the emulsifier composition (b) is present in an amount of 2 to 12% based on a total weight of the alkyd resin (a).

28. The waterborne alkyd composition of claim 26, wherein the emulsifier composition (b) is present in an amount of 2 to 12% based on a total weight of the alkyd resin (a).

29. The waterborne alkyd composition of claim 26, wherein the neutralizer (d) is an alkali metal hydroxide and/or ammonium hydroxide.

30. The waterborne alkyd composition of claim 27, wherein the neutralizer (d) is an alkali metal hydroxide and/or ammonium hydroxide.

31. The waterborne alkyd composition of claim 28, wherein the neutralizer (d) is an alkali metal hydroxide and/or ammonium hydroxide.

32. The waterborne alkyd composition of claim 29, wherein the alkali metal hydroxide is selected from lithium hydroxide, sodium hydroxide, potassium hydroxide, and combinations thereof.

33. A method for producing the waterborne alkyd composition of claim 25, the method comprising:
(A) mixing the alkyd resin (a) with the emulsifier composition (b) to form a mixture;
(B) adding the neutralizer (d) to the mixture under continuous stirring to adjust pH in the range of 5 to 10; and
(C) after achieving the pH, adding water (c) under continuous stirring to form the waterborne alkyd resin.

34. The method of claim 33, wherein the water in (C) is added dropwise.
